(19) United States
(12) Patent Application Publication
(10) Pub. No.: US 2012/0067842 A1
(43) Pub. Date: Mar. 22, 2012

(54) OXYGEN REGULATION MECHANISM FOR A BEVERAGE GASKET

(76) Inventor: Timothy P. Keller, Winters, CA (US)

(21) Appl. No.: 13/051,977

(22) Filed: Mar. 18, 2011

Related U.S. Application Data
(60) Provisional application No. 61/315,510, filed on Mar. 19, 2010.

(51) Int. Cl. B65D 53/00; B26D 3/00

(52) U.S. Cl. 215/261; 83/861

(57) ABSTRACT

A gasket for a bottle closure that regulates the diffusion of oxygen into the bottle is provided. In one example, the gasket includes a flexible substrate permeable to oxygen and a barrier film that is less permeable to oxygen than the substrate layer, where the combined structure has a light transmittance of between 0.5% and 10%. In some examples, the substrate includes a polymer layer and the film comprises a metal or non-metal film, where the film may be vapor deposited or sputtered onto the substrate. The metalized film layer may be deposited on the substrate to allow oxygen to diffuse there through at a rate of 1.5 cc/m²/day to 20 cc/m²/day, or 5 mg of oxygen to diffuse through over a period of 6 months to 8 years. The exemplary gasket or liner may further include a film that is perforated to create areas of differing oxygen transmission through the substrate and film structure.

### CROSS-REFERENCE TO RELATED APPLICATION

This application claims priority from U.S. Provisional application No. 61/315,510, filed Mar. 19, 2010, entitled OXYGEN REGULATION MECHANISM FOR A BEVERAGE GASKET, which is hereby incorporated by reference in its entirety and for all purposes.

### BACKGROUND

1. Field

This application relates generally to bottle enclosures, and more specifically to gaskets for regulating oxygen transmission through a gasket and bottle enclosure.

2. Related Art

The elimination of oxygen ingress into perishable beverage containers has long been desired by industry. With some beverages, however, the complete elimination of oxygen transmission is not desirable. This is especially true in applications that involve maturation of the product over time, such as wine. While excess amounts of oxygen would spoil the wine via premature oxidation, the wine generally requires small amounts of oxygen in order to mature properly, and the lack of such oxygen can lead to the chemical reduction of the beverage over time.

Alongside winemaking, wine bottling technology has evolved over the past several hundred years. The winemaking industry has relied on the use of cork, which allows small amounts of oxygen through, as a sealing medium for wine bottles in the wine aging process. Oxygen that permeates through a wine bottle's cork seal is “consumed” by the bottled wine through the formation of acetaldehyde, which serves as a linking molecule between monomers. This process helps to stabilize longer chains of tannins, resulting in a smoother tasting wine over time.

The use of cork as a wine bottle sealing medium, however, suffers from several deficiencies. For one thing, the variability in natural cork bark, from which cork is made, results in variability in the rate of oxidation of wines in different bottles and consequently, variability in taste across bottles. In addition, cork contains a chemical known as 2,4,6 tricholoroanisole (TCA), a product of fungi that live in natural cork. When 2,4,6 TCA is released into wine, an unwelcome aroma is created. In small amounts, 2,4,6 TCA mutes the wine's aromatics but may completely ruin the wine in larger amounts. Excessive release of 2,4,6 TCA affects 2% to 5% of all corks. Furthermore, cork suffers from structural defects that include crumbling, breaking, and seepage, and requires the use of a tool (e.g., corkscrew) for removal from the wine bottle. Moreover, it is difficult to reseal a cork-sealed wine bottle without the use of additional devices.

Several attempts have been made to introduce wine bottle closure products that aim to rectify some or all of the above deficiencies. These products include: synthetic cork, screw caps, Vino-Lock (a glass stopper with a silicone seal), Zork (a peel-off plastic closure), and others. None of these products, however, has eliminated all of the above deficiencies. For example, while synthetic corks can be made to provide a steady and customizable amount of oxygen flow into a wine bottle, a synthetic cork with an oxygen transfer rate similar to that of cork would use a material so hard that excessive force would be needed to remove it from the wine bottle neck.

The most popular alternative, the screwcap, uses a gasket that contains high-barrier materials; most commonly a layer of tin foil or Poly-vinyl-di-chloride (commonly known as PVDC or Saran). The oxygen transmission rate of these materials, however, is too low to meet the oxygen requirements of most wines.

A closure is desired that would admit moderate amounts of oxygen into the container, but do so in a predictable and selectable, or programmable, way. The amount of oxygen desired for a wine is dependent upon the style of that wine and its needs for oxygen in maturation, but for the theoretical average wine, it can be said that the wine will be in threat of developing oxidized characters by the time 5 ppm of oxygen has entered the bottle. It is then up to the winemaker to decide how long of a time period they would prefer for that bottle to absorb 5 ppm of oxygen.

To match the current styles of wine, the desired amount of oxygen should be allowed into the container over a period of time ranging between 6 months to 8 years. A deciding factor in choosing the appropriate oxygen rate is the wine style and the winemaker's intention for how that wine develops in the bottle. For illustrative purposes, 5 ppm of oxygen over 6 months to 8 years in a standard 750 ml wine bottle equates to a transmission rate of approximately 1.5 ml/m²/day to 20 ml/m²/day.

Several approaches have been suggested to achieve desirable rates of oxygen transmission rate in fluid containers; some have implied that the addition of multiple barrier properties of multiple layers of different materials can arrive at a barrier within the relevant range by summation. For example, U.S. Pat. No. 12/403,082 titled VENTED SCREWCAP CLOSURE WITH DIFFUSIVE MEMBRANE LINER, filed Mar. 12, 2009, the entire contents of which are incorporated herein by reference, describes closure and liner devices for regulating the oxygen through the perforation of liner layers to expose different amounts of surface area in subsequent layers, or to force the oxygen through a tortuous path. While these devices are functional, they may have a mild level of variance due to the delicate nature of aluminum and tin foils used for the closure housings can make them susceptible to physical defects which may significantly affect the performance of the liners. In addition, the perforations of such closure housings generally requires a delicate handling and manufacturing complexity.

### BRIEF SUMMARY OF THE INVENTION

According to one aspect of the present invention, a gasket for a bottle closure that regulates the diffusion of oxygen into the bottle is provided. In one example, the gasket includes a flexible substrate that is at least semi-permeable to oxygen and a barrier film that is less permeable to oxygen than the substrate layer, where the combined structure of the flexible substrate and the film disposed thereon has a light transmittance of between 0.5% and 10%. The structure may further be attached or disposed with an elastomeric liner layer.

In some examples, the substrate includes a polymer layer and the film comprises a metal or non-metal film, where the film may be vapor deposited or sputtered onto the substrate. The film may be deposited on the substrate to allow oxygen to diffuse therethrough at a rate of 1.5 cc/m²/day to 20 cc/m²/day, or 5 mg of oxygen to diffuse therethrough over a period of 6 months to 8 years.

The exemplary gasket or liner may further include a film that is perforated to create areas of differing oxygen transmission through the substrate and film structure. In other examples, the film may be deposited in a manner to create windows or areas of higher and lower oxygen transmission.

According to another aspect of the present invention, a system for perforating a film layer for use in a beverage gasket is provided. In one example, the system includes a processor having a memory and a perforator, wherein the processor is operable to control the perforator to perforate a material having layer formed on a substrate layer in response to an optical density of the material. The perforation may be in response to a measured light transmission or optical density of the material to achieve a desired oxygen transmission rate.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a cross-sectional view of an exemplary bottle cap enclosure and liner disposed therewith.

FIG. 2 illustrates an exploded view of an exemplary liner or gasket for a bottle cap enclosure;

FIG. 3 illustrates an exemplary liner roll for manufacturing liners for a bottle clap enclosure;

FIG. 4 illustrates a table of exemplary film materials and exemplary oxygen transmission rates and light transmission rates;

FIGS. 5 and 6 illustrate schematically exemplary apparatuses for manufacturing liners for use with bottle cap enclosures;

FIG. 7 illustrates a cross-sectional view of various exemplary perforated liners or gaskets for a bottle cap enclosure; and

FIG. 8 illustrates an exemplary computing system.

### DETAILED DESCRIPTION OF THE INVENTION

The following description sets forth numerous specific configurations, parameters, and the like. It should be recognized, however, that such description is not intended as a limitation on the scope of the present invention, but is instead provided as a description of exemplary embodiments.

According to one embodiment provided herein, a closure having a film (for example, comprising metal deposited to a polymer film substrate) is used to regulate the transmission of oxygen into the closure. In one example, the film is processed through control of the optical density (or transparency) of the film. In one example, the film comprises a metalized film. Metal of the metalized film can be applied to a substrate and/or the closure in a variety of suitable ways, including vapor deposition. The exemplary bottle closure may provide a closure that is relatively simple to manufacture and provides a discreet and selectable amount of oxygen permeation to the bottle contents.

Metalized films have been developed to replace metal foils for a number of packaging products, such as potato chip bags and candy bars. Such metal foils are generally applied with the intent of excluding the maximum amount of oxygen practically possible. The benefit of these films is that they approach the oxygen-barrier properties of a foil, but are easier to use in manufacturing and can be made at a significantly lesser cost. The present art for these films fall into two categories: replacement of foils for food packaging where there is very little oxygen let through, or the shielding of materials from light penetration, such as use in reflective exterior windows, or welding shields. In the latter application, oxygen transmission is generally not a relevant metric.

For many materials such as metals (e.g., aluminum, Tin, Zinc, Nickel, etc.) and non-metallic crystals (e.g., ceramics and glasses) deposited onto a polymer film, there is a correlation between the optical density of the film and its oxygen transmission characteristics. For example, the optical transparency of a coated film can be correlated and indexed to an expected oxygen transmission rate. Because of this, the production of a metalized film that meets the desired oxygen transmission levels for bottle contents, e.g., wine bottles, using existing technology and methods can be achieved. With the knowledge of the oxygen barrier properties of the substrate without the deposited material, the oxygen performance of the deposited film can be predicted by measuring an optical density thereof.

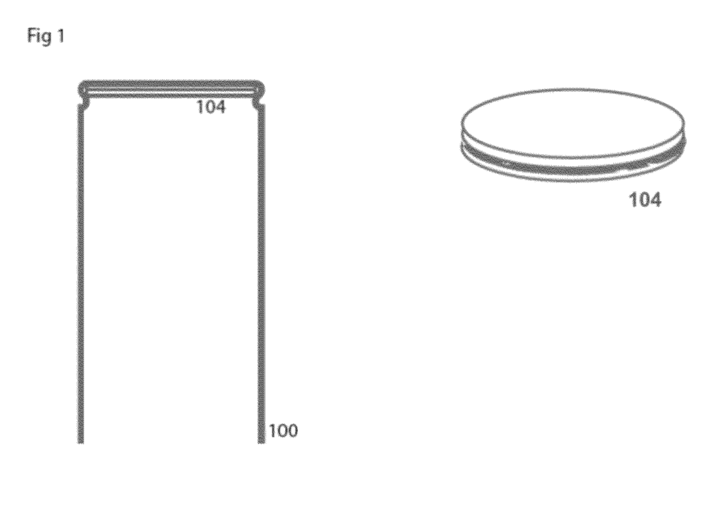

FIG. 1 illustrates a cross-sectional view of an exemplary bottle cap enclosure 100 and liner 104 disposed therewith according to one example. As described in greater detail below, liner 104 may comprise a layer of metalized film with an optical density in the relevant range that allows the metalized film to perform (e.g., allow oxygen transmission) within a desired range for the bottle contents. The below descriptions will refer to a metalized film, but the same or similar structures can be used and produced with other non-metallic, oxygen-regulating materials as mentioned above.

In one example, closure 100 may be constructed from metal such as aluminum or steel that are impermeable to atmospheric air, and contains one or more openings, or ventilation holes, through which atmospheric air can pass to reach liner 104. In one embodiment, closure 100 is a screw cap closure for a wine bottle. It should be noted, however, that other embodiments of the present invention may include liners that are fitted within bottle cap closures other than screw cap closures and bottle cap closures for bottles other than wine bottles.

According to one approach, liner 104 may comprise two or more layers that include at least one semi-permeable layer and at least one impermeable layer. Semi-permeable layers may be constructed from materials that are semi-permeable to oxygen such that oxygen can diffuse through the semi-permeable layers. An example of a material that is semi-permeable to oxygen is polyester. Material for semi-permeable layers may also be slightly elastic so that the semi-permeable layers may be compressed in the areas where the liner is sandwiched between the rim of the bottle below and the screw cap closure above, and further able to stretch when being forced on and/or into the opening of the bottle. This elasticity may fill any irregularities in the sealing surface and ensure a tight seal for the bottle.

Various materials and designs of closure 100 and liner 104 are described, for example, in U.S. patent application Ser. No. 12/403,082 titled VENTED SCREWCAP CLOSURE WITH DIFFUSIVE MEMBRANE LINER, filed Mar. 12, 2009, the entire contents of which are incorporated herein by reference.

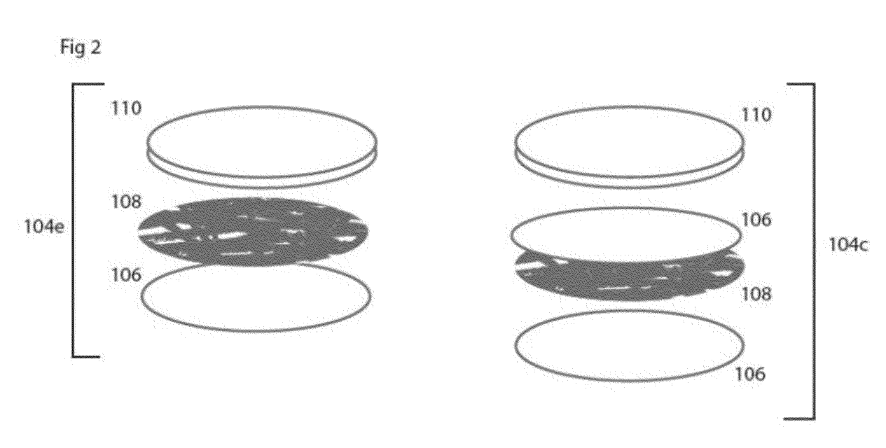

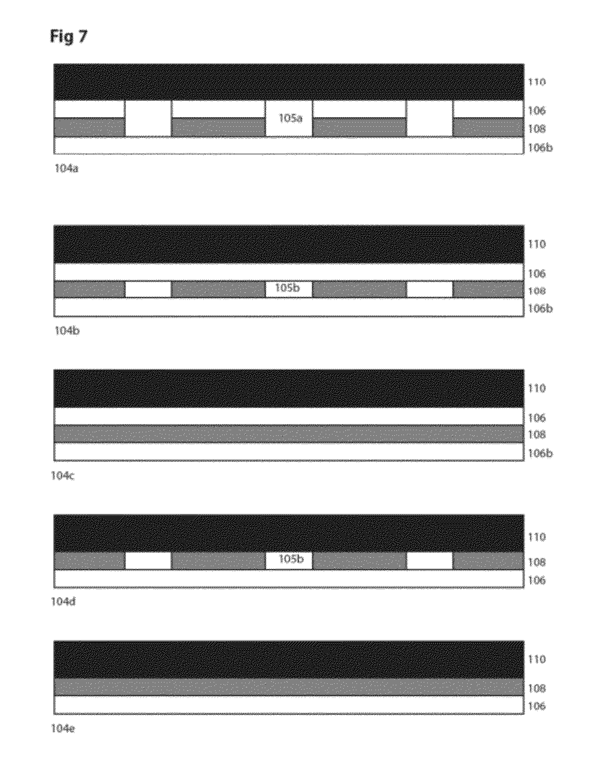

FIG. 2 illustrates exploded views of two exemplary liners 104e and 104c in greater detail (which are also shown in FIG. 7 and discussed below). Liner 104e includes a substrate film, substrate 106, which may include one or more layers that are semi-permeable to oxygen. Exemplary barrier layers can be adhered to an elastomeric gasket layer 110 with the barrier layers oriented towards the bottle lip and the sealing surface of the container.

Further, liner 104e includes a metallization layer 108, which may be formed on substrate 106 through vapor deposition, sputtering, electrochemical deposition, or other suitable processes for fixing metallization layer 108 to substrate 106. In some examples, metallization layer 108 may form a continuous layer on substrate 106; however, in other examples, holes or windows may be present in metallization layer 108 as a result of deposition (e.g., sputtering or a resist pattern) or from post etching or perforating. Additionally, metallization layer 108 may include non-metallic layers as described herein.

Exemplary liner 140c is similar to 104e, however, in this example, metallization layer 108 is disposed between two substrate layers 106. Substrate layers 106 may include the same or different materials, thicknesses, and so on.

For substrate films such as polyester (PET) the degree of light transmission to create a barrier within desired oxygen transmission specifications generally desired for winemaking is between 20% and 0.5%. This degree of metallization will vary with the material due to the nature of the deposition of the metal during the metallization process but is still higher than the current art which aims for very little transmission of oxygen.

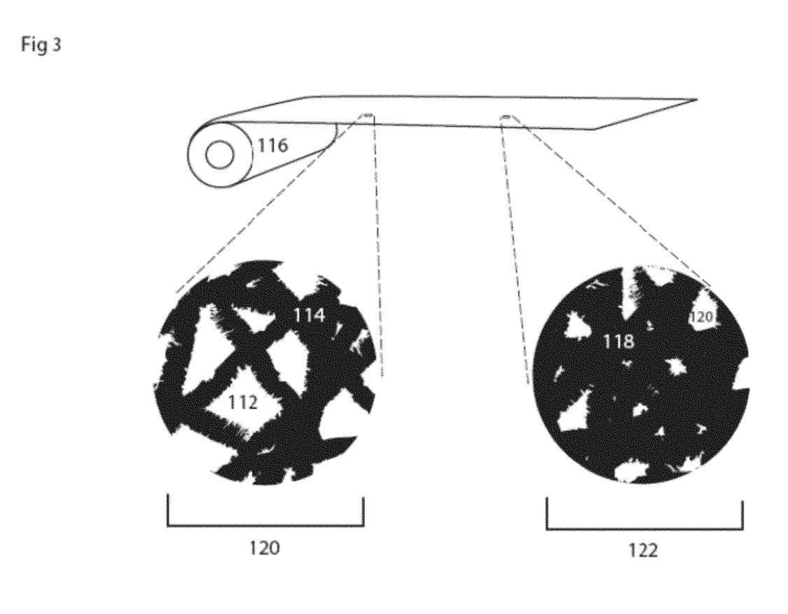

For lower-barrier substrate films, such as polyethylene, the degree of metallization will generally be higher. The cause of this relationship stems from the nature of the deposition of the metal during metallization; for example, the film substrate is being randomly spattered by microscopic particles of metal which sometimes overlap and sometimes leave windows through the film. FIG. 3 illustrates an example where of the structure with different sized windows across a roll. At one optical density 120 there are “windows” 112, where oxygen can move through the barrier film at a rate that is characteristic of that film. Conversely, where the film has specs of adhered metal, 114 the transmission is effectively zero. The degree to which these windows occur in the metalized film generally dictates the transmission of light as well as the diffusion of oxygen through the film. By way of example, a film with a higher density of deposition such as 122 in FIG. 3 will have lower oxygen transmission because its surface area under deposited material 118 is greater than 114 and the surface area of the windows 120 is smaller than that of 112. This change in oxygen transmission can easily be detected optically.

The description of this relationship can be expressed by the equation:

M_{OTR}*L_{TX}=F_{OTR}

where M_{OTR} is the base polymer's Oxygen Transmission Rate (“OTR”), L_{TX} is the % of light transmission (a similar measure of optical density) through the film and F_{OTR} is the resulting oxygen permeability of the manufactured film.

This formula allows a closure manufacturer to spec a film and/or substrate that will provide the desired performance characteristics for a given beverage, container size, substrate film properties, desired oxygen transmission level, and so on.

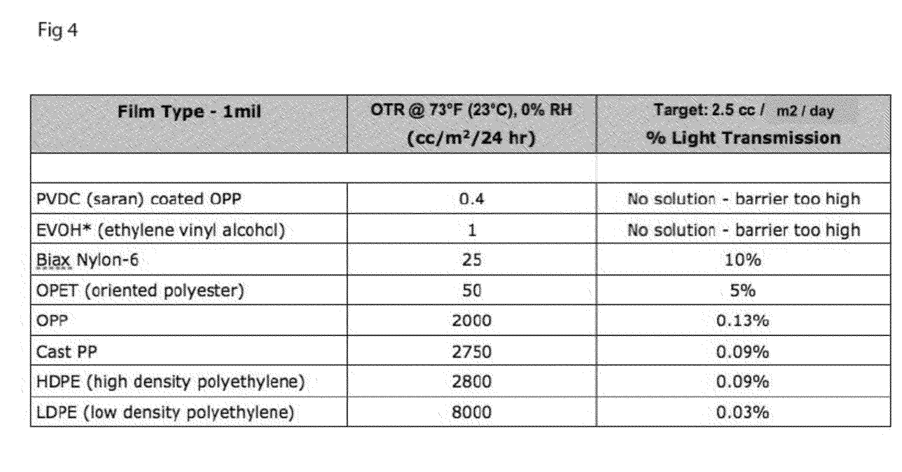

FIG. 4 relates the application of this formula to a table of several known oxygen barrier films and the level of metallization required to bring them to a similar OTR Level. For the purposes of illustration, one appreciates that some films are not acceptable because they do not allow adequate oxygen through by themselves. Other films require such a high level amount of metallization that very small variances in the amount of metallization will produce large changes in OTR.

The current art has focused on material selection as well as regulation of the thickness of these and similar polymers to modify oxygen performance, and the addition of metallization has typically been applied in situations where the highest possible barrier is desired.

One significant advantage to the approach described here is that of consistency. A base polymer that has moderate oxygen permeability can be metalized to a moderate extent to produce the desired result. In the example of OPET, as included in the table of FIG. 4, as much as 5% light transmission is needed for a desired OTR. In this embodiment, a small change in the degree of metallization will not produce a large change in the film's OTR—as it would if a material such as LDPE were used. In the application of such a liner to a product with a long shelf-life such as wine, this degree of consistency is important. The lack of consistency and the extended life expectation of products such as wine is generally the barrier to achieving a high-performance closure. This degree of consistency for products such as wine would be difficult if one were trying to regulate OTR through material thickness or metallization percentage alone.

To further pursue consistency, one may take into account the typical case that within a roll of metalized film 116, and between rolls of metalized film, there may be internal variations in the optical density, thickness of the substrate film, and so on (e.g., as shown in FIG. 3). This is expected due to the nature of the film extrusion process as well as the metalizing process which is subject to variations at the beginning or end of a run, changes in roll speed, and the random nature of the deposition process itself.

Another advantage of the indexing of oxygen transmission to the optical density of a metalized film is that optical density can be measured in real-time in a manufacturing environment using optical sensors. For example, using an optical sensor to detect optical density as a roll is fed into the lamination or die cutting system. In contrast, the alternative of measuring oxygen transmission directly requires long-duration, and generally destructive, testing of portions of the metalized film.

This real-time ability gives a manufacturer an opportunity to adjust to or sort within variations within a film on the fly when this metalized film barrier is used to replace the perforated foil layer proposed by U.S. patent application Ser. No. 12/402,082, referenced above. For example, in one embodiment, the metalized film can be perforated to a greater or lesser extent, e.g., by a computer-controlled laser, based on the level of metallization detected in the material at that point.

As illustrated in FIG. 7, and described in greater detail below, the perforated layers (e.g., 106 and 108) can be laminated over a medium-barrier layer 106b to create a “windowing” effect that may effectively regulate the amount of area of the medium-barrier that is exposed.

While oxygen will still come through the metalized film in direct correlation with its optical density, these windows 105a will provide areas of higher diffusion, and changes in the size of these windows will allow the system to adjust in real-time to any variances in the optical density of the metalized film.

Such a system would allow variable oxygen transmission according to the following formula:

(F_{OTR}*A_{F})+(MB_{OTR}*(1−_{AF}))=P_{OTR}

### Where:

F_{OTR}=The oxygen transmission rate of the high barrier layer;
MB_{OTR}=The oxygen transmission rate of the medium barrier layer; and
A_{f}=The % of the membrane surface area covered by the high barrier layer.

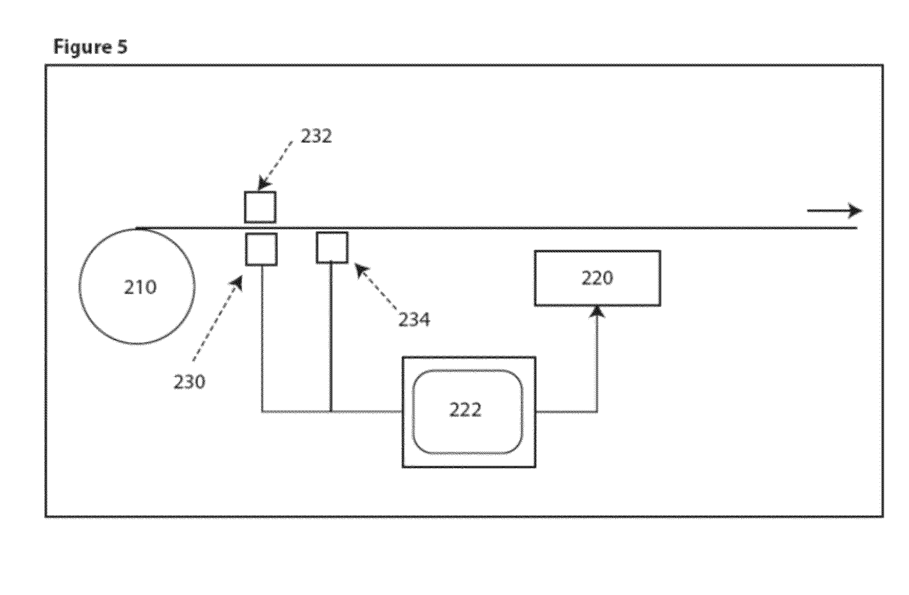

FIG. 5 illustrates schematically an exemplary apparatus for manufacturing liners for use with bottle cap enclosures. In this example, a roll of metalized film 210 is fed through an optical detector 230 and through a perforator apparatus 220. The metalized film may include one or more substrate layers having at least one surface thereof metalized. For example, via a vapor deposition process a desired amount of metal on the substrate may have been achieved.

The metalized film 210 passes through or by an optical detector, which may include a light or laser source 232 and a detector 230 for detecting optical transmission properties of the metalized film 210 as it passes. For example, optical detector 230 may operate with a light source having a known average wavelength (e.g., 550 nm), a laser tuned to a particular wavelength, or other means for passing light through the metalized film 210 to the optical detector 230. Optical detector 230 may monitor the optical transmission properties of metalized film 210 in predetermined intervals or continuously. It may also be placed at representative locations or across the width of the web in a continuous array.

The detected optical transmission properties may be communicated to processor 222 and/or perforator apparatus 220 along with information from a web speed sensor 234 for use in determining the degree, if any, that the film should be perforated by perforator apparatus 220. For example, apparatus may include a laser or a hot needle array to create perforations through the entire film or the metallization layer may be selectively removed or thinned by use of select laser wavelengths, mechanical or chemical etching, or similar process). The amount of selective removal or thinning may be in response to the optical characteristics determined by optical detector 230.

After processing by perforator apparatus 220, metalized film 210 may be again rolled or stored for further manufacturing. In other examples, metalized film 210 may further pass directly to an apparatus for forming enclosure liners and/or to bottling apparatus to be included as part of a finished bottle enclosure.

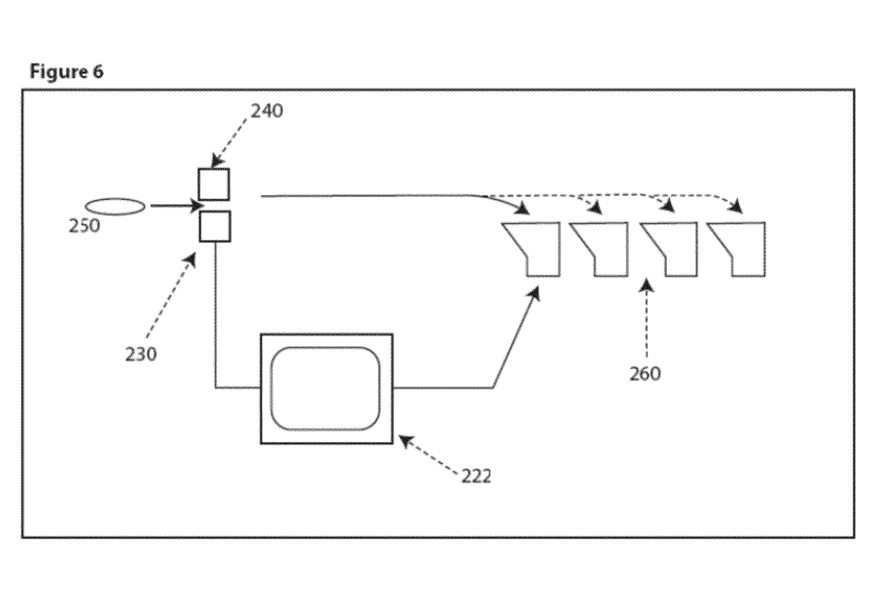

FIG. 6 illustrates schematically another application of optical transmission based correction of variance in the manufacturing process. In this embodiment, the light is transmitted through a fully assembled and die cut liner. Since the other components of the liner are translucent or transparent, differences in optical density at this stage will still be predictive of OTR.

In this embodiment the light source 240 may be pulsed like a strobe to maximize intensity of the transmitted light. The light readings from sensor 230 may be transmitted to a computer processor 222 which controls the operation of a mechanical sorting grid 260. The sorting function will serve to use any variance within the product itself as an opportunity to create multiple levels of oxygen transmission, and allow the product to be sorted into different performance levels.

These real-time methods of variance-checking and correction will allow for extremely consistent products to be constructed. This is of critical importance for long-term storage applications such as wine where a very small change in oxygen transmission can have large consequences over time.

FIG. 7 illustrates several cross-sectional views of an exemplary perforated liner 104 for a bottle cap enclosure, one embodiment 104a which has been perforated, for example, by the systems of FIG. 5 or 6. As illustrated, a series of windows or openings 105a have been formed in metalized layers 108 by perforating through both layers. In this embodiment the openings 105a are formed completely through to the substrate 106b, whereas in embodiment 104b the windows are formed only through metal layer 108. This difference in structure can be accomplished with short-wavelength lasers such as nd-YAG, fiber lasers, and similar. Further, the spacing between openings 105a and 105b may vary, depending, for example, on detected optical transmission properties and desired oxygen transmission rates. Those rates may be varied by altering either the size or the number of windows, or a combination of both.

In still another embodiment 104c there are no downstream perforations of the metalized film and the oxygen regulation is provided by the optical density alone.

In embodiment 104a there are two layers of substrate 106, 106b—largely for the purpose of encapsulating the metalized layer and the perforations therein. This is necessary to protect the metalized layer from contact with the contents of the bottle, to guard against accidental over-penetration by the laser and to provide a more robust seal with the bottle.

However, with the selective removal of metal from the substrate (or by selectively preventing its deposition in the first place as described above) it is possible to do away with the secondary substrate lamination and allow the construction of embodiments 104d and 104e. In these embodiments the metalized film is laminated to the elastomer 110 of the gasket directly. Allowing for a simpler structure and lower cost.

By starting with a liner such as that detailed by 104c a range of products of different oxygen transmission rates can be created by programming in a minimum amount of perforations to increase the overall permeability. This makes fine tuning and customization of oxygen rates possible while starting from one common set of base materials.

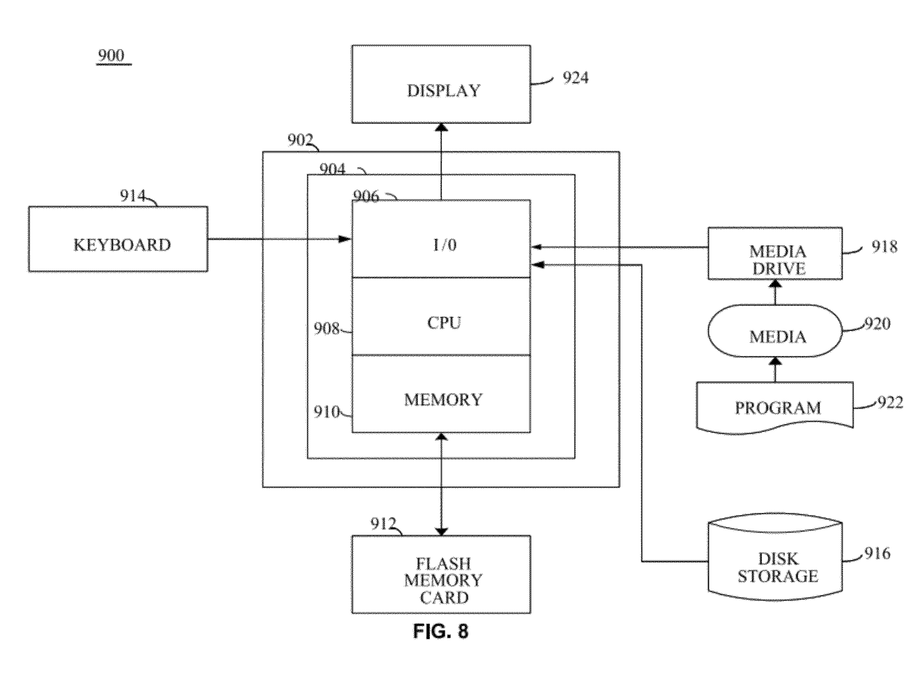

FIG. 8 depicts computing system 900 with a number of components that may be used to perform the above-described processes. For example, computing system 900 may be part of or in communication with one or more of a metallization system, perforator system, optical detector system, closure apparatus, and so on. The main system 902 includes a motherboard 904 having an input/output (“I/O”) section 906, one or more central processing units (“CPU”) 908, and a memory section 910, which may have a flash memory card 912 related to it. The I/O section 906 is connected to a display 924, a keyboard 914, a disk storage unit 916, and a media drive unit 918. The media drive unit 918 can read/write a computer-readable medium 920, which can contain programs 922 and/or data.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed as new and desired to be protected by Letters Patent of the United States is:

1. A gasket for a bottle closure that regulates the diffusion of oxygen into the bottle, the gasket comprising:
a flexible substrate layer; and
a film deposited on the substrate layer, wherein the combined structure of the substrate layer and the film disposed thereon has a light transmittance of between 0.5% and 10%.

2. The gasket of claim 1, wherein the substrate layer is a moderate oxygen barrier material having an oxygen transmission rate greater than 2 cc/ M²/day but less than 1000 cc/M²/day.

3. The gasket of claim 1, wherein the film comprises a vapor-deposited metal film.

4. The gasket of claim 1, wherein the film comprises a non-metallic film.

5. The gasket of claim 1, wherein the film comprises a vapor-deposited or sputtered material.

6. The gasket of claim 1, wherein the substrate layer comprises a polymer layer.

7. The gasket of claim 1, wherein the film layer allows oxygen to diffuse there through at a rate of 1.5 cc/m²/day to 20 cc/m²/day.

8. The gasket of claim 1, wherein the film layer allows 5 mg of oxygen to diffuse through over a period of 6 months to 10 years.

9. The gasket of claim 1, wherein the oxygen transmission rate of the film layer can be predicted by use of the equation: M_{OTR}*L_{TX}=F_{OTR}, where M_{OTR} is the substrate oxygen transmission rate, L_{Tx} is the % of light transmission through the film, and F_{OTR} is the resulting oxygen permeability of the film.

10. The gasket of claim 1, wherein the film lies between two solid polymer layers.

11. The gasket of claim 1, wherein the film lies between the substrate polymer film on which it was deposited and a flexible elastomeric layer.

12. The gasket of claim 1, where the film is perforated to create areas of differing oxygen transmission.

13. The gasket of claim 1, where the film deposition alone is removed to create areas of higher oxygen transmission.

14. A bottle enclosure comprising the gasket of claim 1.

15. A bottle comprising the gasket of claim 1.

16. A system for perforating a film layer for use in a beverage gasket, the system comprising:
a processor having a memory; and
a perforator, wherein the processor is operable to control the perforator to perforate a film layer comprising a layer formed on at least one substrate layer in response to an optical density of the film layer, the film layer perforated in accordance with:
(F_{OTR}*A_{F})+(MB_{OTR}*(1-A_{F}))P_{OTR}
where F_{OTR} is the oxygen transmission rate of the film layer, MB_{OTR} is the oxygen transmission rate of the at least one substrate layer, and A_{f} is the percentage of the at least one substrate layer surface area covered by the film layer.

17. The dynamic perforation system of claim 16, further comprising an optical sensor for determining the optical density of a portion of the film layer.

18. The dynamic perforation system of claim 16, wherein the surface area adjustment is adjusted by changing the number of holes, the hole size, the hole shape, or a combination of one or more thereof.

19. The dynamic perforation system of claim 16, wherein the perforations are made only in the film layer while leaving the at least one substrate layer intact.

20. The dynamic perforation system of claim 16, wherein the perforator utilizes one or more of the following to remove portions of the metalized film: energy, chemical reaction, mechanical removal, or a printing resist.

21. The dynamic perforation system of claim 16, wherein the film layer comprises a metal film.

22. The dynamic perforation system of claim 16, wherein the film layer comprises a non-metallic film.
